(19) United States
(12) Patent Application Publication
(10) Pub. No.: US 2014/0281028 A1
(43) Pub. Date: Sep. 18, 2014

(54) DELIVERY DEVICE, DELIVERY METHOD, ASSOCIATION INFORMATION GENERATION DEVICE, ASSOCIATION INFORMATION GENERATION METHOD, CONTROL PROGRAM, AND RECORDING MEDIUM

(71) Applicant: SHARP KABUSHIKI KAISHA, Osaka-shi, Osaka (JP)

(72) Inventors: Shuichi Watanabe, Osaka-shi (JP); Maki Takahashi, Osaka-shi (JP); Takuya Iwanami, Osaka-shi (JP)

(21) Appl. No.: 14/352,570

(22) PCT Filed: Oct. 18, 2012
(86) PCT No.: PCT/JP2012/076944

§ 371 Date: Apr. 17, 2014

(30) Foreign Application Priority Data
Oct. 21, 2011 (JP) 2011-232223
Jan. 31, 2012 (JP) 2012-019156
Jul. 18, 2012 (JP) 2012-160038

(51) Int. Cl. H04L 12/721

(52) U.S. Cl. CPC H04L 45/14
USPC 709/242

(57) ABSTRACT

A secondary delivery server includes a route determination unit that determines a delivery route of each component by using component management information that contains route information used to identify a delivery route of the component, and a delivery control unit that delivers the component using the delivery route determined by the route determination unit.

### TECHNICAL FIELD

The present invention relates to hybrid delivery of multi-component content, and more particularly to determination of a delivery route of a component to be delivered by means of hybrid delivery.

### BACKGROUND ART

“Hybrid delivery” is known in which content is delivered by using a plurality of networks having different characteristics (for example, PTL 1 below). As an example of hybrid delivery, hybrid delivery of multi-component content, “multi-component content” being constituted by a plurality of components having different characteristics, has been drawing attention in which the components are delivered using a plurality of delivery routes having different characteristics.

In the case where hybrid delivery of multi-component content is performed, a suitable delivery route differs depending on the characteristic of the component (for example, the medium type or contents of the component) and therefore an appropriate delivery route needs to be determined for each component.

For example, it is desirable that a large-volume component or a component having the same delivery contents independent of the client be delivered by means of one-way broadcast delivery (for example, broadcasting). On the other hand, it is desirable that a small-volume component or a component having different delivery contents depending on the client be delivered by means of unicast delivery, that is, by means of communication where bidirectional request-response-type delivery is performed.

Therefore, a delivery route of content is properly controlled by a distributor (content creator) of the content. Such control will be described with reference to FIG. 15. FIG. 15 is a block diagram illustrating configurations of principal parts of primary delivery servers 100, 100′ and 100″ and a client 101 that constitute a delivery system according to the related art.

The primary delivery server 100 is a server that generates and delivers content, and includes a medium generation unit 110, a formatting unit 111, and a transmission unit 112.

The medium generation unit 110 generates a medium of content. Specifically, the medium generation unit 110 generates a medium (video data, audio data, or the like) of content inputted by a content creator.

The formatting unit 111 formats the medium generated by the medium generation unit 110 and generates a component. The transmission unit 112 transmits the component generated by the formatting unit 111.

The primary delivery servers 100′ and 100″ also have functions and configurations similar to those of the primary delivery server 100. That is, in the primary delivery server 100′, a medium generated by a medium generation unit 110′ is formatted (the medium is stored in a delivery format or a delivery format is formed) by a formatting unit 111′, and is delivered from a transmission unit 112′. In the primary delivery server 100″, a medium generated by a medium generation unit 110″ is formatted by a formatting unit 111″, and is delivered from a transmission unit 112″.

One of the differences among the primary delivery servers 100, 100′ and 100″ is a difference in their delivery routes for components. That is, the delivery routes used by the transmission units 112, 112′, and 112″ are different from one another. For example, the transmission unit 112 may perform delivery using a broadcast route, the transmission unit 112′ may perform delivery using a communication route that enables multicast, and the transmission unit 112″ may perform delivery using a communication route that enables only unicast. Note that a broadcast route is a route used in the case where delivery is performed using broadcast waves, and a communication route is a route used in the case where delivery is performed by means of communication over the Internet or the like.

Another difference among the primary delivery servers 100, 100′ and 100″ is a difference in components that they deliver. That is, components respectively delivered by the primary delivery servers 100, 100′ and 100″ are combined together to constitute one piece of content. In other words, the primary delivery servers 100, 100′ and 100″ respectively deliver components that constitute one piece of content.

As described above, the primary delivery servers 100, 100′ and 100″ deliver components that they have created respectively by using the transmission units 112, 112′, and 112″ that they respectively have. That is, hybrid delivery is performed by the primary delivery servers 100, 100′ and 100″.

Note that hybrid delivery may be performed by one server. A server used in this case includes the medium generation units 110, 110′, and 110″, the formatting unit 111, 111′, and 111″, and the transmission units 112, 112′, and 112″.

It is determined in advance by a content creator or the like, for example, that a component generated by the formatting unit 111 is delivered by the transmission unit 112. Similarly, it is determined in advance that a component generated by the formatting unit 111′ is delivered by the transmission unit 112′ and a component generated by the formatting unit 111″ is delivered by the transmission unit 112″.

The client 101 receives components (hybrid delivery components) delivered using such a plurality of delivery routes, and combines and displays the components. As illustrated, the client 101 includes a first reception unit 120, a second reception unit 120′, a third reception unit 120″, a first medium restoration unit 121, a second medium restoration unit 121′, a third medium restoration unit 121″, and a combining/display unit 122.

The first reception unit 120 receives a component transmitted by the transmission unit 112 of the primary delivery server 100. Similarly, the second reception unit 120′ receives a component transmitted by the transmission unit 112′ of the primary delivery server 100′, and the third reception unit 120″ receives a component transmitted by the transmission unit 112″ of the primary delivery server 100″.

The first medium restoration unit 121 restores the medium from the component received by the first reception unit 120. Similarly, the second medium restoration unit 121′ restores the medium from the component received by the first reception unit 120′, and the third medium restoration unit 121″ restores the medium from the component received by the first reception unit 120″.

The combining/display unit 122 combines and displays media respectively restored by the first medium restoration unit 121, second medium restoration unit 121′, and third medium restoration unit 121″. In this way, components delivered by means of hybrid delivery are displayed to a user as one piece of content.

As described above, one server has managed from generation of a medium to delivery of a component, and a delivery route of a component has been uniquely determined by a content creator or the like. As a result, delivery using a delivery route that meets a content creator's intention has been implemented.

### CITATION LIST

### Patent Literature

PTL 1: Japanese Unexamined Patent Application Publication No. 10-173612

### SUMMARY OF INVENTION

### Technical Problem

Heretofore, delivery of multi-component content as described above from a server that is not a content creator has not been assumed. Accordingly, it has been difficult for a server that is not a content creator to deliver components that constitute content using appropriate delivery routes.

That is, there is a case where multi-component content as described above is managed while the content is in a form of components (the content remains formatted), and a server that is not a content creator uses the multi-component content. In this case, a server that is not a content creator has to handle the content on a component-by-component basis.

However, a server that is not a content creator does not know an appropriate delivery route of each component of the multi-component content. The server does not know the contents of each component, either. Particularly, an archive, a secondary delivery server that handles a component that has been delivered, or the like according to the related art has no means for acquiring the foregoing information, and there is no clue for identifying a delivery route of a component at all.

Even if information regarding a medium corresponding to a component is determined by an analysis or the like of the component, the contents of the component will not be uniquely linked with an appropriate delivery route. Accordingly, in order to determine an appropriate delivery route, a server has to perform certain determination. In the case where such determination is made for each component, the time required before delivery becomes long.

As described above, the related art has a problem in that it is very difficult for a server (delivery device) that delivers content constituted by a plurality of components to determine an appropriate delivery route of each component.

It is assumed that the above problem will become serious when a situation arises in the future in which multi-component content is registered in an archive or in a secondary delivery server and any server may deliver such content.

The present invention has been made in view of the foregoing problem, and an object thereof is to provide a delivery device and the like that can easily determine delivery routes of components that constitute content.

### Solution to Problem

To solve the foregoing problem, a delivery device of the present invention is a delivery device that delivers content constituted by a plurality of components. The delivery device includes route determination means for determining, by using association information in which pieces of route information used to identify delivery routes of the components are associated with the components, a delivery route of each of the components, and delivery control means for delivering each of the components using the delivery route determined by the route determination means.

To solve the foregoing problem, a delivery method of present invention is a delivery method performed by a delivery device that delivers content constituted by a plurality of components. The delivery method includes a route determination step of determining, by using association information in which pieces of route information used to identify delivery routes of the components are associated with the components, a delivery route of each of the components, and a delivery control step of delivering each of the components using the delivery route determined in the route determination step.

With the foregoing configuration, a delivery route of each component is determined by using association information in which route information used to identify a delivery route of each component is associated with the component, and the component is delivered using the determined delivery route.

Accordingly, with the foregoing configuration, it is not necessary to perform an analysis or the like of the contents of a component in order to determine a delivery route, and a delivery route of each component that constitutes part of content can be easily determined and the component can be easily delivered.

Note that the foregoing association information may be in a form in which route information is associated with the component itself (for example, a header of the component), or may be information managed separately from the component (for example, information in a table format or in an XML format).

The foregoing route information may be any information that can be used to identify a delivery route of a component. For example, the route information may be information that directly indicates a specific delivery route (a broadcast route, a communication route, or the like), or may be information that indicates the characteristics (bidirectional, unidirectional, multicast, unicast, or the like) of a delivery route. Furthermore, the route information may be information indicating that delivery using a specific delivery route is permitted (recommended) or prohibited.

Note that the foregoing component constitutes part of a piece of content, and is a component part that can be delivered using a different route from those of other component parts. For example, video data and audio data that constitute one piece of animation content can be delivered using different routes respectively and therefore each of the video data and audio data can be the foregoing component.

To solve the foregoing problem, an association information generation device of the present invention includes route information determination means for determining, for components constituting content, pieces of route information used to identify delivery routes of the components, and association information generation means for generating association information by associating the pieces of route information determined by the route information determination means with the components.

To solve the foregoing problem, an association information generation method of the present invention is an association information generation method performed by an association information generation device. The association information generation method includes a route information determination step of determining, for components constituting content, pieces of route information used to identify delivery routes of the components, and an association information generation step of generating association information by associating the pieces of route information determined in the route information determination step with the components.

With the foregoing configuration, for components constituting content, pieces of route information used to identify delivery routes of the components are determined, and association information is generated by associating the determined pieces of route information with the components.

Therefore, by using the association information, it is not necessary to perform an analysis or the like of the contents of a component in order to determine a delivery route, and a delivery route of each component that constitutes part of content can be easily determined and the component can be easily delivered.

Note that a device that performs delivery by using the generated association information may be the association information generation device or another delivery device. In the case where another delivery device performs delivery, the association information may be transmitted to the other delivery device.

Note that the foregoing delivery device and the foregoing association information generation device may be implemented by using a computer. In this case, a control program that makes a computer implement the delivery device or the association information generation device by making the computer operate as the means of the delivery device or the association information generation device, and a computer readable recording medium that records the control program are also within the scope of the present invention.

### Advantageous Effects of Invention

As described above, the delivery device of the present invention includes route determination means for determining, by using association information in which pieces of route information used to identify delivery routes of the components are associated with the components, a delivery route of each of the components, and delivery control means for delivering each of the components using the delivery route determined by the route determination means.

As described above, the delivery method of the present invention includes a route determination step of determining, by using association information in which pieces of route information used to identify delivery routes of the components are associated with the components, a delivery route of each of the components, and a delivery control step of delivering each of the components using the delivery route determined in the route determination step.

With the foregoing configuration, a delivery route of each component is determined by using association information in which route information used to identify a delivery route of each component is associated with the component, and the component is delivered using the determined delivery route.

Accordingly, it is not necessary to perform an analysis or the like of the contents of a component in order to determine a delivery route, which is effective in that a delivery route of each component that constitutes part of content can be easily determined and the component can be easily delivered.

As described above, the association information generation device of the present invention includes route information determination means for determining, for components constituting content, pieces of route information used to identify delivery routes of the components, and association information generation means for generating association information by associating the pieces of route information determined by the route information determination means with the components.

As described above, the association information generation method of the present invention is an association information generation method performed by an association information generation device. The association information generation method includes a route information determination step of determining, for components constituting content, pieces of route information used to identify delivery routes of the components, and an association information generation step of generating association information by associating the pieces of route information determined in the route information determination step with the components.

With the foregoing configuration, for components constituting content, pieces of route information used to identify delivery routes of the components are determined, and association information is generated by associating the determined pieces of route information with the components.

Therefore, by using the association information, it is not necessary to perform an analysis or the like of the contents of a component in order to determine a delivery route, which is effective in that a delivery route of each component that constitutes part of content can be easily determined and the component can be easily delivered.

### BRIEF DESCRIPTION OF DRAWINGS

FIG. 1 illustrates an embodiment of the present invention, and is a block diagram illustrating an example of a configuration of a principal part of a secondary delivery server that constitutes part of a delivery system.

FIG. 2 is a block diagram illustrating examples of configurations of primary delivery servers, a secondary delivery server, and a client that constitute the delivery system.

FIG. 3 is a block diagram illustrating an example of a configuration of a principal part of one of the primary delivery servers.

FIG. 4 includes diagrams illustrating an example of component management information in which route information that specifies bidirectional delivery is set for components. FIG. 4(a) illustrates an example in a table format, and FIG. 4(b) illustrates an example in an XML format.

FIG. 5 includes diagrams illustrating an example of component management information in which route information that specifies multicast delivery or unicast delivery is set for each component. FIG. 5(a) illustrates an example in a table format, and FIG. 5(b) illustrates an example in an XML format.

FIG. 6 is a flowchart illustrating an example of component management information generation processing performed by the primary delivery server.

FIG. 7 is a flowchart illustrating an example of delivery processing performed by the secondary delivery server.

FIG. 8 includes diagrams illustrating an example of component management information in which route information that specifies bidirectional delivery is set for a group of components. FIG. 8(a) illustrates an example in a table format, and FIG. 8(b) illustrates an example in an XML format.

FIG. 9 includes diagrams illustrating an example of component management information in which route information that specifies bidirectional delivery is set for a multiplexed component. FIG. 9(a) illustrates an example in a table format, and FIG. 9(b) illustrates an example in an XML format.

FIG. 10 is a block diagram illustrating examples of configurations of primary delivery servers, a secondary delivery server, and a client that constitute a delivery system according to another embodiment of the present invention.

FIG. 11 is a block diagram illustrating an example of a configuration of a principal part of the secondary delivery server.

FIG. 12 is a flowchart illustrating an example of service route information generation processing performed by the secondary delivery server.

FIG. 13 is a block diagram illustrating examples of configurations of a primary delivery server and a client that constitute a delivery system according to yet another embodiment of the present invention.

FIG. 14 is a block diagram illustrating an example of a configuration of a principal part of the primary delivery server.

FIG. 15 illustrates the related art, and is a block diagram illustrating configurations of principal parts of primary delivery servers and a client that constitute a delivery system according to the related art.

FIG. 16 includes block diagrams schematically illustrating delivery systems according to yet another embodiment of the present invention. FIG. 16(a) illustrates an example without a relay server, and FIG. 16(b) illustrates an example including a relay server.

FIG. 17 includes diagrams illustrating examples of component management information in which a plurality of pieces of route information can be described for one component and an example of component management information in which a plurality of pieces of route information can be described for one piece of route information. FIG. 17(a) illustrates an example of component management information in which two pieces of route information are described for one component, FIG. 17(b) illustrates an example of component management information in which acquisition source information is described for each of two pieces of route information, and FIG. 17(c) illustrates an example of component management information in which two pieces of acquisition source information are described for one piece of route information.

FIG. 18 illustrates an example of a case where both of information indicating error resilience of a component and information indicating delay tolerance of a component are selected, combined, and used.

FIG. 19 is a diagram illustrating small values and large values of errors and delays in the case illustrated in FIG. 18 where both of information indicating error resilience of a component and information indicating delay tolerance of a component are selected, combined, and used.

### DESCRIPTION OF EMBODIMENTS

Hereinafter, embodiments of the present invention will be described in detail with reference to FIGS. 1 to 14.

### First Embodiment

A first embodiment of the present invention will be described with reference to FIGS. 1 to 9. First, a delivery system according to this embodiment will be described with reference to FIG. 2. FIG. 2 is a block diagram illustrating examples of configurations of primary delivery servers (association information generation devices) 1, 1′, and 1″, a secondary delivery server (delivery device) 2, and a client 3 that constitute a delivery system 4 of this embodiment.

[Configuration of Primary Delivery Server 1]

The primary delivery server 1 is a server that generates and delivers content, and includes a medium generation unit 10, a formatting unit 11, a route setting unit (route information determination means, association information generation means) 12, and a first transmission unit 20. The primary delivery server 1 is different from the primary delivery server 100 according to the related art illustrated in FIG. 15 in that it includes the route setting unit 12 that generates component management information (association information) containing route information used to identify a delivery route of a component.

However, in the primary delivery servers 1, 1′, and 1″ in FIG. 2, corresponding delivery routes have been determined in advance for the first transmission unit 20, a second transmission unit 20′, and a third transmission unit 20″ respectively. Therefore, component management information generated in any of the primary delivery servers 1, 1′, and 1″ will not be directly used for delivery performed by the primary delivery server. Component management information generated by any of the primary delivery servers is delivered to the secondary delivery server 2, and is directly used for delivery performed by the secondary delivery server or is used for the secondary server to form component management information by bringing components together.

The medium generation unit 10 generates a medium (video data, audio data, or the like) of content to be delivered. The formatting unit 11 formats the medium generated by the medium generation unit 10 (stores the medium in a delivery format or forms a delivery format), and generates a component. Examples of a delivery format include a transmission format according to MPEG-2 TS and an MP4 file format. The first transmission unit 20 delivers the component generated by the formatting unit 11 and the component management information generated by the route setting unit 12.

Note that a medium described here indicates instance data that is replayed or displayed as a component part that constitutes part of one piece of content, such as video or audio, and such medium data is usually coded, stored in a predetermined delivery format as descried above, and delivered. That is, generated media are components (component parts) that constitute one piece of content. In addition, text data, such as a caption, and an application, such as a widget that is displayed together with video, are also components. To simplify description, in the present description, unless otherwise specially noted, a medium that has been formatted in a predetermined format for delivery will be distinctively called a component.

As a matter of course, a form in which delivery of a medium is performed on a component-by-component basis, the component being obtained by formatting the medium in a predetermined format for delivery, is merely one embodiment of the present invention. A “component”, which is a unit of delivery in the present invention, may be anything as long as the component is a component part that constitutes part of one piece of content and is subjected to hybrid delivery.

Component management information is information used to manage a component and includes route information used to identify a delivery route of each component as described above. Therefore, a delivery route of a component can be identified by referring to such component management information.

The route setting unit 12 generates route information that indicates a delivery route of a component, combines the route information with information indicating the component to thereby generate component management information. As described above, component management information generated here is used for delivery performed by the secondary delivery server 2. Processing of generating component management information performed by the route setting unit 12 (and the secondary delivery server 2) and the component management information will be described in detail below.

The primary delivery servers 1′ and 1″ are servers that generate and deliver content like the primary delivery server 1. These servers have functions similar to that of the primary delivery server 1 except that the servers have different delivery routes for components. That is, the second transmission unit 20′ of the primary delivery server 1′ delivers a component using a route that is different from a route that the first transmission unit 20 of the primary delivery server 1 uses. The third transmission unit 20″ of the primary delivery server 1″ delivers a component using a route that is different from routes that the first transmission unit 20 and second transmission unit 20′ use.

Note that FIG. 2 illustrates an example in which delivery is performed by three primary delivery servers using three patterns of delivery routes. However, the number of delivery routes may be any number as long as there are a plurality of delivery routes. That is, delivery may be performed by two primary delivery servers using two patterns of delivery routes.

FIG. 2 illustrates an example in which delivery using a plurality of routes is performed by using a plurality of primary delivery servers. However, delivery using a plurality of routes may be performed by including a plurality of transmission units in one primary delivery server.

[Configuration of Secondary Delivery Server 2]

The secondary delivery server 2 is a server that receives and stores content (multi-component content) delivered by the primary delivery server 1, and delivers the content to the client 3. As illustrated, the secondary delivery server 2 includes a first reception unit 40, a second reception unit 40′, a third reception unit 40″, a storage unit 41, a selection unit 50, a first transmission unit 42, a second transmission unit 42′, and a third transmission unit 42″.

The first reception unit 40 receives a component and component management information transmitted from the first transmission unit 20 of the primary delivery server 1. Similarly, the second reception unit 40′ receives a component and component management information transmitted from the second transmission unit 20′ of the primary delivery server 1′. The third reception unit 40″ receives a component and component management information transmitted from the third transmission unit 20″ of the primary delivery server 1″.

The storage unit 41 stores various types of data used in the secondary delivery server 2. The foregoing components and component management information are also stored in the storage unit 41.

The selection unit 50 determines a delivery route of a component stored in the storage unit 41 on the basis of component management information similarly stored in the storage unit 41. The selection unit 50 thereafter selects a transmission unit (any one of the first transmission unit 42, second transmission unit 42′, and third transmission unit 42″) in accordance with the determined delivery route, and delivers the component from the selected transmission unit.

The first transmission unit 42 delivers a component in accordance with control performed by the selection unit 50. The same applies to the second transmission unit 42′ and third transmission unit 42″. However, the first transmission unit 42, second transmission unit 42′, and third transmission unit 42″ respectively use different delivery routes for components. For example, the first transmission unit 42 may perform delivery using a broadcast route, the second transmission unit 42′ may perform delivery using a communication route that enables multicast, and the third transmission unit 42″ may perform delivery using a communication route that enables only unicast. Alternatively, a combination may be possible such that the first transmission unit 42 performs delivery using a route for main broadcasting among broadcast routes, the second transmission unit 42′ performs delivery using a route for data broadcasting among broadcast routes, and the third transmission unit 42″ performs delivery using a communication route.

[Configuration of Client 3]

The client 3 receives content (multi-component content) delivered by the secondary delivery server 2 by means of hybrid delivery, and combines the components and displays the content. As illustrated, the client 3 includes a first reception unit 70, a second reception unit 70′, a third reception unit 70″, a first medium restoration unit 71, a second medium restoration unit 71′, a third medium restoration unit 71″, and a combining/display unit 72. Here, the medium restoration units are units that perform processing of restoring a data stream of a medium from formatted components and processing of restoring a replay medium by decoding a coded data stream. The client 3 has a configuration similar to that of the client 101 according to the related art illustrated in FIG. 15 and therefore a description thereof will be omitted.

[Major Features of Delivery System 4]

As described above, in the delivery system 4, components primarily delivered by the primary delivery servers 1, 1′, and 1″ are received by and stored in the secondary delivery server 2, and the components are secondarily delivered by the secondary delivery server 2 to the client 3.

In the delivery system 4, the primary delivery servers 1, 1′, and 1″ each generate component management information that specifies route information for each component, and deliver the component together with the component management information.

Accordingly, the secondary delivery server 2 can perform delivery to the client 3 using routes that meet intentions of the primary delivery servers 1, 1′, and 1″ (intentions of content creators) without performing troublesome processing, such as an analysis or the like of components, by referring to component management information. The component management information in the secondary delivery server 2 may be component management information generated by any of the primary delivery servers, or may be component management information formed by bringing components together.

[Detailed Configuration of Primary Delivery Server 1]

Next, a more detailed configuration of the primary delivery server 1 will be described with reference to FIG. 3. FIG. 3 is a block diagram illustrating an example of a configuration of a principal part of the primary delivery server 1. As illustrated, the primary delivery server 1 includes the first transmission unit 20, a control unit 21, and a storage unit 22.

The control unit 21 is a unit that totally controls the function of the primary delivery server 1, and includes the medium generation unit 10, the formatting unit 11, the route setting unit 12, and a delivery control unit 13. The storage unit 22 is a unit that stores various types of data used by the primary delivery server 1, and stores a component 30 and component management information 31.

As described above, the medium generation unit 10 generates a medium, the formatting unit 11 formats the generated medium and generates a component, and the route setting unit 12 generates component management information that contains route information for each component that has been generated. In the illustrated example, a component generated by the formatting unit 11 is stored as the component 30. Component management information generated by the route setting unit 12 is stored as the component management information 31.

The delivery control unit 13 delivers the component 30 and component management information 31 stored in the storage unit 22 to another apparatus via the first transmission unit 20. Here, a description will be given while assuming that a delivery destination is the secondary delivery server 2, however, a delivery destination may be the client 3, another delivery server (a tertiary delivery server), or the like.

[Configuration of Secondary Delivery Server]

Next, a detailed configuration of the secondary delivery server 2 will be described with reference to FIG. 1. FIG. 1 is a block diagram illustrating an example of a configuration of a principal part of the secondary delivery server 2. As illustrated, the secondary delivery server 2 includes the first reception unit 40, the second reception unit 40′, the third reception unit 40″, the storage unit 41, the first transmission unit 42, the second transmission unit 42′, the third transmission unit 42″, and a control unit 43.

As described above, the first reception unit 40, second reception unit 40′, and third reception unit 40″ are units that receive components and component management information. As illustrated, a component and component management information received by any of these reception units are stored in the storage unit 41 as a component 60 and component management information 61.

The control unit 43 is a unit that totally controls the function of the secondary delivery server 2, and includes the selection unit 50 that determines a delivery route of each component 60 and delivers the component 60 via a transmission unit that corresponds to the determined delivery route. The selection unit 50 includes a delivery control unit (delivery control means) 51 and a route determination unit (route determination means) 52 in order to implement such a function.

The delivery control unit 51 reads the component 60 from the storage unit 41 and inquires of the route determination unit 52 about a transmission route of the component 60. The delivery control unit 51 thereafter transmits the component 60 from a transmission unit (any one of the first transmission unit 42, second transmission unit 42′, and third transmission unit 42″) determined in accordance with a response to the inquiry. Hereinafter, a delivery route used by the first transmission unit 42 will be called a first delivery route, a delivery route used by the second transmission unit 42′ will be called a second delivery route, and a delivery route used by the third transmission unit 42″ will be called a third delivery route.

When the route determination unit 52 has received an inquiry about a route from the delivery control unit 51, the route determination unit 52 determines a delivery route of the component 60 on the basis of the component management information 61 stored in the storage unit 41. The route determination unit 52 communicates to the delivery control unit 51 information indicating the determined delivery route as a response to the received inquiry.

The first transmission unit 42, second transmission unit 42′, and third transmission unit 42″ deliver the component 60 and component management information 61 in accordance with control performed by the selection unit 50 as described above. However, delivery of the component management information 61 is not essential. In the case where it is obvious that the component management information 61 will not be referred to in a subsequent delivery destination, delivery of the component management information 61 may be omitted. A delivery destination may be the client 3 or another server (a tertiary deliver server).

[Examples of Component Management Information]

Next, specific examples of the component management information will be described with reference to FIGS. 4 and 5.

[Specify Bidirectional Delivery]

FIG. 4 includes diagrams illustrating an example of the component management information in which route information that specifies bidirectional delivery is set for components. FIG. 4(a) illustrates an example in a table format, and FIG. 4(b) illustrates an example in an XML format. Note that the component management information in FIG. 4 is an example of information in a form where a plurality of components are brought together and described, that is, component management information formed by the secondary delivery server 2. Content corresponding to the illustrated component management information has a name “cont1”, and is constituted by components “compA” to “compM”.

In the example of FIG. 4(a), a character string “bidirectional” is associated with “compB” and “compM”. “bidirectional” is information indicating that the components are for bidirectional delivery (bidirectional delivery is essential).

Accordingly, it is possible to identify that “compB” and “compM” are components for bidirectional delivery. As a result, a server (for example, the secondary delivery server 2) that is not a creator of the content can determine that “compB” and “compM” are to be delivered using a delivery route (for example, a communication route) that enables bidirectional delivery.

Note that, “bidirectional” may be associated with an interactive component or a component for which use/non-use is selectable for each user (the client 3) so as to make such a component be a component for bidirectional delivery. On the other hand, “bidirectional” is not associated with a component to be simultaneously delivered, a large-volume component, a user-independent component, or the like so as to make such a component be a component for unidirectional delivery.

On the other hand, the character string “bidirectional” is not associated with “compA”. Accordingly, it is found that “compA” is not a component for bidirectional delivery. Such a component may be delivered using a delivery route (for example, a broadcast route) for unidirectional delivery.

In the example of FIG. 4(b), it is indicated in a form “trans=“bidirectional”” that the components are for bidirectional delivery. Even if component management information is in such a format, it is possible to identify “compB” and “compM” as components for bidirectional delivery, and “compA” as a component not for bidirectional delivery, among components that constitute the content named “cont1”. Note that, in the example of FIG. 4(b), in an omitted portion (portion of “ . . . ”) in each <component> element, information (attribute information, such as the codec format or coding rate) regarding a medium contained in the component, information (such as the file name or acquisition source URL) regarding an acquisition source, and the like are described.

In FIGS. 4 and 5, examples of component management information are illustrated in which, for each component that constitutes part of one piece of content, route information of the component is specified. That is, component management information in the secondary delivery server 2 is illustrated. However, component management information may be such that it specifies route information of at least one component.

For example, in the case where the primary delivery servers 1, 1′, and 1″ each generate component management information as in the delivery system 4 in FIG. 2, a plurality of pieces of component management information are generated for one piece of content and managed. That is, pieces of component management information respectively generated by the primary delivery servers 1, 1′, and 1″ are managed by the secondary delivery server as they are, which has no problem because delivery routes can be determined using such information.

As a matter of course, pieces of component management information corresponding to one piece of content may be brought together, which can be implemented by adding inside or outside the secondary delivery server 2 a configuration for integrating the pieces of component management information corresponding to the same piece of content, for example.

[Specify Unicast Delivery or Multicast Delivery]

FIG. 5 includes diagrams illustrating an example of component management information in which route information that specifies multicast delivery or unicast delivery is set for each component. FIG. 5(a) illustrates an example in a table format, and FIG. 5(b) illustrates an example in an XML format.

Note that multicast delivery is a delivery form in which the same component is simultaneously delivered to a plurality of clients, and delivery by means of broadcasting belongs to this delivery form. On the other hand, unicast delivery is a delivery form in which a component is separately delivered to each client. A form of delivery by means of communication in which a component is delivered in response to a request made by a client belongs to this delivery form.

In the example of FIG. 5(a), a character string “unicast” is associated with “compB” and “compM”. “unicast” is information indicating that the components are for unicast delivery. A character string “multicast” is associated with “compA”. “multicast” is information indicating that the component is for multicast delivery.

As a result, even a server (for example, the secondary delivery server 2) that is not a creator of the medium can determine that “compB” and “compM” are to be delivered by means of unicast delivery using a delivery route that enables unicast delivery, by referring to such component management information. Furthermore, it is possible to determine that “compA” is to be delivered by means of multicast delivery using a delivery route that enables multicast delivery.

In the example of FIG. 5(b), it is indicated, in a form “trans=“unicast””, that the components are for unicast delivery and, in a form “trans=“multicast””, that the component is for multicast delivery. Even if component management information is in such a format, it is possible to identify “compB” and “compM” as components for unidirectional delivery, and “compA” as a component for multicast delivery, among components that constitute the content named “cont1”.

### Other Examples

Route information contained in component management information may be any information (information that serves as a reference used to determine a delivery route) as long as a delivery route can be determined on the basis of such information, and is not limited to the foregoing examples.

For example, information that identifies a delivery route in terms of functionality may be used as route information. Specifically, it is possible to use information that indicates immediacy, responsiveness, high reliability, or the like may be used as route information. In this case, the secondary delivery server 2 selects a transmission unit from among the first transmission unit 42, second transmission unit 42′, and third transmission unit 42″ on the basis of their immediacy, responsiveness, and high reliability. For example, a component with which information indicating immediacy or responsiveness is associated may be delivered using a communication route. A component with which information indicating high reliability is associated may be delivered using a broadcast route.

Among pieces of information that specify delivery routes in terms of functionality, examples of information, used as route information, which indicates high reliability, include information indicating error resilience of a component (for example, “loss#priority”) and information indicating delay tolerance of a component (for example, “delay#priority”). Here, “loss#priority” (error resilience information) may have priority levels, such as “11: loss priority 0 (lossless)”, “10: loss priority 1 (lossy, high priority)”, “01: loss priority 2 (lossy, medium priority)”, and “00: loss priority 3 (lossy, low priority)”, for example. “delay#priority” (delay tolerance information) may have priority levels, such as “11: high sensitivity: end-to-end delay <<1 sec”, “10: medium sensitivity: end-to-end delay approx. 1 sec”, “01: low sensitivity: end-to-end delay <5-10 sec”, and “00: don't care”, for example.

As information indicating high reliability, either one of the information indicating error resilience of a component and information indicating delay tolerance of a component may be selected and used, or both pieces of information may be selected, combined, and used.

Here, an example of a case will be described in which either one of the information indicating error resilience of a component and information indicating delay tolerance of a component is selected and used as information indicating high reliability. If information indicating high reliability is the information that indicates error resilience of a component and has the priority level “11: loss priority 0 (lossless)”, information (for example, “broadband”) indicating that the component is for broadband delivery can be associated with the component as route information. If information indicating high reliability is the information that indicates delay tolerance of a component and has the priority level “11: high-sensitivity: end-to-end delay <<1 sec”, information (for example, “multicast”) indicating that the component is for multicast delivery can be associated with the component as route information.

FIG. 18 illustrates an example of a case in which both of the information indicating error resilience of a component and information indicating delay tolerance of a component are selected, combined, and used. For example, in the case where information that indicates error resilience of a component, the information indicating error resilience of a component having the priority level “11: loss priority 0 (lossless)”, and information that indicates delay tolerance of a component, the information indicating delay tolerance of a component having the priority level “00: don't care”, are selected and combined, information (for example, “unicast”) indicating that the component is for unicast delivery can be associated with the component as route information. For example, in the case where information that indicates error resilience of a component, the information indicating error resilience of a component having the priority level “00: loss priority 3”, and information that indicates delay tolerance of a component, the information indicating delay tolerance of a component having the priority level “11: high sensitivity: end-to-end delay”, are selected and combined, information (for example, “broadcast”) indicating that the component is for broadcast delivery can be associated with the component as route information.

In the example of FIG. 4, “bidirectional”, which is information indicating that the component is for bidirectional delivery (bidirectional delivery is essential), is associated with the component, however, information is not limited to the foregoing information. For example, information indicating that a specific delivery mode is prohibited or allowed, such as information indicating that bidirectional delivery is allowed (bidirectional delivery is recommended but not essential) or information indicating that bidirectional delivery is prohibited, may be associated with the component.

Similarly, in the example of FIG. 5, information indicating that multicast delivery is allowed, information indicating that multicast delivery is prohibited, information indicating that unicast delivery is allowed, information indicating that unicast delivery is prohibited, or the like may be included in the component management information as route information.

In the case where the secondary delivery server 2 makes a selection on the basis of route information indicating that a specific delivery mode is allowed, a delivery route corresponding to the allowed delivery mode is used in preference to other delivery routes. If the allowed delivery mode cannot be used, another delivery route is used. In the case where the secondary delivery server 2 makes a selection on the basis of route information indicating that a specific delivery mode is prohibited, the secondary delivery server 2 selects a delivery route corresponding to a delivery mode other than the prohibited delivery mode.

In the foregoing cases, there is a possibility that a delivery route cannot be uniquely identified. However, at least delivery routes are narrowed down and therefore an appropriate delivery route can be easily selected compared with a case of not using the component management information.

Route information is not limited to the foregoing information that indicates the characteristic (bidirectional, multicast, unicast, or the like) of a delivery route, and may be information that directly indicates a delivery route. For example, information (for example, “broadband”) indicating that the deliver route is for broadcast delivery or information (for example, “broadcast”) indicating that the deliver route is for communication delivery may be used as route information.

Alternatively, information that directly indicates a delivery route and information that indicates the characteristic of a delivery route are combined so as to define detailed route information. For example, a direc attribute that indicates the characteristic of a delivery route is defined in addition to a trans attribute that directly indicates a delivery route, so as to represent route information using these two attributes.

In this case, component management information of the component compA is described as follows, for example, by using information “trans=“broadcast”” indicating that the delivery route is for broadcast delivery and “direc=“bidirectional”” indicating that the bidirectional function is necessary (for bidirectional delivery).

<component name=“compA” trans=“broadcast” direc=“bidirectional”/>

In this example, “broadcast” indicates the type of the downward route, and “bidirectional” indicates that an upward route is necessary in addition to the downward route when the component is used. Note that the type of an upward route is not limited to “broadcast” and a normal communication line may be used as an upward route.

Furthermore, it is possible to define a trans element that directly indicates a delivery route and to add to the trans element a bidirectional attribute that indicates whether or not bidirectionality is necessary, so that the whole element represents route information. For example, a trans element defined by the following schema is an example of the forgoing case.

```
<element name=trans type=“transType”/>
<complexType name=“transType”>
    <attribute name=“cast” type=“castType”/>
    <attribute name=“bidirectional” type=“xs:boolean”/>
</complexType>
<simpleType name=“castType”>
    <restriction base=“string”>
        <enumeration value=“broadcast”/>
        <enumeration value=“unicast”/>
        <enumeration value=“multicast”/>
    </restriction>
</simpleType>
```

In accordance with the definition based on the above schema, the component compA, a delivery route of which is “broadcast” and for which the bidirectional function is necessary (for bidirectional delivery), is described as follows.

<component name=“compA”>
<trans cast=“broadcast” bidirectional=“true”/>
</component>

An example of determining a delivery route using component management information, which is data separated from the component has been described. However, component management information may be in any form as long as a delivery route of each component can be identified. For example, a data header of a component may include route information indicating a delivery route of the component.

[Flow of Component Management Information Generation Processing]

Next, a flow of component management information generation processing (association information generation method) performed by the primary delivery server 1 will be described with reference to FIG. 6. FIG. 6 is a flowchart illustrating an example of component management information generation processing. Note that FIG. 6 illustrates processing to be performed after a medium has been generated by the medium generation unit 10.

First, the formatting unit 11 formats a medium generated by the medium generation unit 10 as a component and stores the component in the storage unit 22 as the component 30 (S1). The formatting unit 11 communicates to the route setting unit 12 that the component 30 has been stored. Note that an example of generating one component from one medium will be described here, however, a plurality of components may be generated from one medium.

The route setting unit 12 that has received the above communication determines route information for each component 30 that has been stored (S2, route information determination step). Specifically, the route setting unit 12 determines route information by making a user of the primary delivery server 1 (for example, a creator of the medium) input a delivery route of the component 30. As a result, it also becomes possible to make the secondary delivery server 2 perform delivery using a delivery route that meets an intention of the creator of the medium.

Note that determination of route information may be automatically performed by the route setting unit 12. For example, the primary delivery server 1 includes only the first transmission unit 20 as a configuration for performing delivery. Therefore, the route setting unit 12 may automatically determine route information that indicates a delivery route used by the first transmission unit 20.

Automatic determination of route information may be performed on the basis of information obtained from attribute information or the like regarding the medium or component. In this case, the route setting unit 12 may refer to attribute information that indicates the attribute of the component and a criterion for determination determined in advance for each delivery route and, if the attribute information regarding the component meets the criterion for determination, determine route information that meets the criterion for determination to be route information of the component.

For example, communication delivery, which is bidirectional delivery, may not be appropriate for transmission of large-volume data. Therefore, a criterion for determination on route information that indicates bidirectional delivery may be based on the file size of the component. Then, the file size obtained from attribute information contained in header information or the like of the component and a certain threshold may be compared. If the file size is equal to or less than the threshold, route information that indicates a bidirectional delivery route may be determined and, if the file size is larger than the threshold, route information that indicates a unidirectional delivery route may be determined.

Note that route information corresponding to a component is information that indicates a delivery route that is to be used when the component is delivered to the client 3. Therefore, in the case where direct delivery from the primary delivery server 1 to the client 3 is not performed as in the delivery system 4 in FIG. 2, route information that indicates a delivery route that is not supported by the first transmission unit 20 may be determined.

When determination of route information of the component has been completed, the route setting unit 12 associates the determined route information with the component and stores the component management information in the storage unit 22 as the component management information 31 on the content corresponding to the medium (S3, association information generation step).

Note that component management information is generated by the primary delivery server 1, which is a primary delivery source of content and therefore route information contained in component management information will be handled as information specific to the component and will not be basically subjected to modification or the like in a delivery destination.

In this way, an intention of a creator of content can be clearly reflected in the second and subsequent deliveries. That is, delivery using delivery routes that meet a creator's intention can be performed in the second and subsequent deliveries.

[Flow of Delivery Processing]

Next, a flow of delivery processing (delivery method) performed by the secondary delivery server 2 will be described with reference to FIG. 7. FIG. 7 is a flowchart illustrating an example of delivery processing. First, the delivery control unit 51 reads the component 60 from the storage unit 41 (S10), and communicates the read component 60 to the route determination unit 52.

When the route determination unit 52 has received this communication, the route determination unit 52 determines a delivery route by using the component management information 61 (S11, route determination step). Specifically, the route determination unit 52 identifies route information associated with the component 60 that has been communicated from the delivery control unit 51, by using the component management information 61. Then, the route determination unit 52 determines any of the first to third delivery routes to be a delivery route of the component 60 on the basis of the route information.

When the route determination unit 52 has determined a delivery route as described above, the route determination unit 52 communicates the determined delivery route to the delivery control unit 51. When the delivery control unit 51 has received this communication, the delivery control unit 51 checks whether the delivery route determined by the route determination unit 52 is the first, second, or third delivery route (S12).

If it has been confirmed that the determined delivery route is the first delivery route, the delivery control unit 51 selects the first transmission unit 42 as a transmission unit that transmits the component 60 (S13). On the other hand, if it has been confirmed that the determined delivery route is the second delivery route, the delivery control unit 51 selects the second transmission unit 42′ (S14), and if it has been confirmed that the determined delivery route is the third delivery route, the delivery control unit 51 selects the third transmission unit 42″ (S15).

Then, the delivery control unit 51 delivers the component 60 from the transmission unit selected as described above (S16, delivery control step), and delivery processing of one component ends. By performing this delivery processing for each component, a whole piece of content is delivered and the client 3 displays (replays) the content by combining the components 60 that have been delivered.

[Setting of Route Information for Each Group of Components]

An example has been described above in which route information is set for each component. However, route information may be set for a group constituted by a plurality of components, which will be described with reference to FIG. 8.

FIG. 8 includes diagrams illustrating an example of component management information in which route information that specifies bidirectional delivery is set for a group of components. FIG. 8(a) illustrates an example in a table format, and FIG. 8(b) illustrates an example in an XML format. Note that content corresponding to the illustrated component management information has a name “cont2” and is constituted by two groups, that is, “groupA” including “compA-1” to “compA-L” and “groupB” including “compB-1” to “compB-M”.

In the example of FIG. 8(a), a character string “bidirectional” is associated with “groupB”. This character string is route information indicating that the components are for bidirectional delivery (bidirectional delivery is essential) as described above.

Accordingly, in the case where route information is set for a group of components, route information for the components that belong to the group can be indicated collectively. That is, in the illustrated example, all components from “compB-1” to “compB-M” that belong to “groupB” are for bidirectional delivery.

On the other hand, the character string “bidirectional” is not associated with “groupA”. Therefore, bidirectional delivery is not essential for any component from “compA-1” to “compA-L” that belong to “groupA”.

In the example of FIG. 8(b), it is indicated in a form “trans=“bidirectional”” that the components are for bidirectional delivery. This character string is added to the component group name.

Even if component management information is in such a format, it is possible to identify the components belonging to “groupB” as components for bidirectional delivery, and the components belonging to “groupA” as components not for bidirectional delivery, among components that constitute the content named “cont2”.

Component management information in the foregoing form is preferable in the case where components are handled as a group (for example, in the case where the second delivery is performed for each group or in the case where components in a group are multiplexed and used).

In the case where component management information in the foregoing form is generated, in S3 in FIG. 6, components to which the same route information has been set are extracted and grouped, and route information is set for each group to thereby generate component management information.

[Setting of Route Information for Multiplexed Component]

Route information may be set for components that have been multiplexed, which will be described with reference to FIG. 9. FIG. 9 includes diagrams illustrating an example of component management information in which route information that specifies bidirectional delivery is set for a multiplexed component. FIG. 9(a) illustrates an example in a table format, and FIG. 9(b) illustrates an example in an XML format.

Note that content corresponding to the illustrated component management information has a name “cont2” and is constituted by “muxcompA” obtained by multiplexing “compA-1” to “compA-L” and “muxcompB” obtained by multiplexing “compB-1” to “compB-M”.

FIG. 9(a) includes a table in which “muxcompA” and “muxcompB” are associated with “cont2”, a table in which “compA-1” to “compA-L” are associated with “muxcompA”, and a table in which “compB-1” to “compB-M” are associated with “muxcompB”.

The table in which “muxcompA” and “muxcompB” are associated with “cont2” is a table that illustrates the configuration of “cont2”. That is, this table indicates that “cont2” is constituted by “muxcompA” and “muxcompB”, which are multiplexed components.

The table in which “compA-1” to “compA-L” are associated with “muxcompA” is a table that illustrates the configuration of “muxcompA”. That is, this table indicates that “muxcompA” is constituted by multiplexing “compA-1” to “compA-L”. Similarly, the table in which “compB-1” to “compB-M” are associated with “muxcompB” is a table that illustrates the configuration of “muxcompB”, and indicates that “muxcompB” is constituted by multiplexing “compB-1” to “compB-M”.

In the table in which “muxcompA” and “muxcompB” are associated with “cont2”, the character string “bidirectional” indicating that the multiplexed component is for bidirectional delivery (bidirectional delivery is essential) is associated with “muxcompB”.

As described above, route information can be set for a multiplexed component. In the illustrated example, “muxcompB” is for bidirectional delivery but bidirectional delivery is not essential for “muxcompA” with which the character string “bidirectional” is not associated.

The example of FIG. 9(b) includes a description indicating that “cont2” is constituted by “muxcompA” and “muxcompB”, which are multiplexed components, and a description describing the configurations of “muxcompA” and “muxcompB”, as in the example of FIG. 9(a). In the description describing the configuration of “cont2”, the character string “trans=“bidirectional””, which indicates that the multiplexed component is for bidirectional delivery, is added to “muxcompB”.

Even if component management information is in such a format, it is possible to identify the multiplexed component named “muxcompB” as a multiplexed component for bidirectional delivery, among multiplexed components that constitute the content named “cont2”. Furthermore, it is possible to identify the multiplexed component named “muxcompA” as a multiplexed component not for bidirectional delivery.

Note that, in FIGS. 8 and 9, examples are illustrated in which “bidirectional” is used as an example of route information. However, route information may be any information as long as a route can be identified from the information, and is not limited to the foregoing examples. For example, route information that indicates unicast delivery or multicast delivery as illustrated in FIGS. 5(a) and 5(b) may be used. Alternatively, route information indicating that delivery using a specific delivery route is allowed or prohibited, which has been described, may be used.

### Second Embodiment

Next, a second embodiment of the present invention will be described with reference to FIGS. 10 to 12. A delivery system according to this embodiment will be described first with reference to FIG. 10. FIG. 10 is a block diagram illustrating examples of configurations of the primary delivery servers 1, 1′, and 1″, a secondary delivery server (delivery device) 80, and the client 3 that constitute a delivery system 5 according to this embodiment. Note that a configuration similar to that in the foregoing embodiment is given the same reference numeral and a description thereof will be omitted.

The delivery system 5 is different from the delivery system 4 of the foregoing embodiment in that the secondary delivery server 2 is replaced by the secondary delivery server 80. The secondary delivery server 80 is different from the secondary delivery server 2 in that the secondary delivery server 80 includes a service design unit (secondary association information generation means) 53.

The service design unit 53 generates service route information (secondary association information) in which route information is set for each component, on the basis of component management information. Accordingly, it is possible to specify a delivery route in accordance with a criterion unique to the secondary delivery server 80 while using component management information generated by the primary delivery server 1 or the like as a base.

In the first embodiment, fixed route information is given to each component by a creator or the like of a medium. In the second embodiment, however, it is assumed that a secondary distributor sets a delivery route of a component on its own and delivers the component. Here, such delivery of multi-component content independently performed by a distributor is called a service. Note that delivery performed by the delivery server 1 or the like in the first embodiment may also be a service that is performed independently by a creator of a medium, that is, a distributor.

Specifically, the secondary delivery server 80 generates service route information, in which route information is set for each component on its own, for each assumed service. Then, the secondary delivery server 80 performs delivery of the component by using the generated service route information. It is also possible to transmit the generated service route information to another delivery server to make the delivery server perform delivery in accordance with the service route information.

As described above, a component delivery service using a different delivery route depending on the secondary distributor is implemented even for the same medium, by employing a configuration in which the secondary delivery server 80 sets route information on its own.

For example, it is assumed that a secondary delivery operator generates service route information specifying that, for a medium constituted by three components, A, B, and C, A and B are to be delivered by means of unidirectional delivery and C is to be delivered by means of bidirectional delivery. On the other hand, it is assumed that another secondary delivery operator generates service route information specifying that A is to be delivered by means of unidirectional delivery and B and C are to be delivered by means of bidirectional delivery.

In this case, the delivery route of the component B differs between the two secondary delivery operators. Accordingly, a secondary delivery operator can perform a delivery service using a delivery route different from a delivery route used by another secondary delivery operator even for the same medium, by generating service route information. That is, an intention of a secondary delivery operator can be reflected in a delivery route. A client can receive delivery of a component from a secondary delivery operator that provides a delivery service using a delivery route that meets client's preference.

[Configuration of Secondary Delivery Server]

Next, a more detailed configuration of the secondary delivery server 80 will be described with reference to FIG. 11. FIG. 11 is a block diagram illustrating an example of a configuration of a principal part of the secondary delivery server 80. The secondary delivery server 80 is different from the secondary delivery server 2 in that the control unit 43 includes the service design unit 53, and the storage unit 41 stores service route information 62.

The service design unit 53 generates route information for each component on the basis of the component management information 61, associates the route information with the component, and stores them in the storage unit 41 as the service route information 62. The service design unit 53 may generate a plurality of different pieces of service route information 62 and store them.

The service route information 62 is information that specifies route information for each component that constitutes part of content as in the component management information 61 and therefore the data structure thereof is similar to that of the component management information 61.

However, since the service route information 62 is present, it becomes necessary to determine whether the component management information 61 is used or the service route information 62 is used when a delivery route is to be determined. In the case where a plurality of pieces of service route information 62 have been generated, it may become necessary to select one that is to be used from among the plurality of pieces of service route information 62.

Accordingly, it is preferable that the service route information 62 contain information that serves as a reference used for selection. For example, the service route information 62 for a broadcaster may contain information to that effect, and the service route information 62 for a telecommunication carrier may contain information to that effect. In this way, in the case where a server that has received the service route information 62 is a telecommunication carrier, the server can select the service route information 62 to that effect. The same applies to a case where a server that has received the service route information 62 is a broadcaster. The service route information 62 may contain information specifying information to be used in the case where the component management information 61 is also present. Furthermore, the service route information 62 may contain information that identifies a creator of the service route information 62 or information that identifies the secondary delivery server 80 that has generated the service route information 62. Selection based on such references is made by a secondary delivery server, another server (tertiary delivery server), or a client.

[Flow of Service Route Information Generation Processing]

Next, a flow of service route information generation processing, which is processing performed by the secondary delivery server 80 for generating the service route information 62, will be described with reference to FIG. 12. FIG. 12 is a flowchart illustrating an example of service route information generation processing.

First, the service design unit 53 refers to the component management information 61 stored in the storage unit 41 and reads route information corresponding to each component 60 (S20). Then, the service design unit 53 determines route information corresponding to each component on the basis of the read route information (S21).

Specifically, the service design unit 53 determines, for each component 60, whether or not it is possible for the secondary delivery server 80 to perform delivery using a delivery route indicated by the route information in the component management information 61. If delivery is possible, the service design unit 53 determines the route information in the component management information 61 to be route information for the component. On the other hand, if delivery is not possible, the service design unit 53 replaces the route information in the component management information 61 with route information indicating a delivery route with which delivery is possible.

For example, in the case where any of the first transmission unit 42, second transmission unit 42′, and third transmission unit 42″ is unable to perform delivery using a broadcast route, route information indicating delivery using a broadcast route is replaced with appropriate route information that indicates a delivery route with which the first transmission unit 42, second transmission unit 42′, or third transmission unit 42″ is able to perform delivery. In this case, an appropriate route is selected as necessary such that a communication route that enables multicast delivery, which is close to a broadcast route, is selected, for example. A criterion for selection of a route may be determined in advance. Accordingly, the service route information 62 adapted to the secondary delivery server 80 can be generated while respecting an intention of a content creator that has been reflected in the component management information 61.

When the service design unit 53 has determined pieces of route information for all components that constitute one piece of content, the service design unit 53 associates each of the determined pieces of route information with the corresponding component and stores them in the storage unit 41 as the service route information 62 for the medium (S22). Here, the service design unit 53 may bring together components corresponding to the same route information in a group and set route information for each group (see FIGS. 8(a) and 8(b)).

In the foregoing example, the service route information 62 in accordance with a delivery route that the secondary delivery server 80 can support is generated, however, the service route information 62 is not limited to the foregoing example. For example, the service design unit 53 may determine route information by making a display device display route information for each component 60, for example, thereby showing the route information for each component 60 to a user (for example, a secondary delivery operator) of the secondary delivery server 80, and by making the user input new route information for each component 60. If the service route information 62 generated by using such route information is used, it becomes possible to reflect an intention of a secondary delivery operator in determination of a delivery route used by the secondary delivery server 80 and a delivery route used in the third and subsequent deliveries.

Furthermore, the service design unit 53 may detect the condition of a connection route between the secondary delivery server 80 and the client 3 and set a delivery route in accordance with the result of detection. As a result, an appropriate delivery route in accordance with the condition of the connection route can be set. For example, in the case where a delay has been detected in communication between the secondary delivery server 80 and the client 3, route information specifying a broadcast route may be set.

Service route information may be appropriately generated by collecting and analyzing pieces of information regarding connection routes owned by a plurality of clients and using a combination of optimum delivery routes. In this case, it is also possible to extract representative combinations of routes with which delivery can be performed and to generate a plurality of pieces of service route information that correspond to the combinations.

The service design unit 53 may make the client 3 select a delivery route. For example, the service design unit 53 adds information indicating a delivery route that can be supported by the secondary delivery server 80 to each component that constitutes a medium, and transmits it to the client 3. The information indicating a delivery route that can be supported may be information that indicates a plurality of delivery routes (for example, a broadcast route and a communication route). Next, the client 3 determines a desired delivery route for each component on the basis of the received information and communicates the result of determination to the secondary delivery server 80. The service design unit 53 generates route information for each component in accordance with the communicated result and generates service route information from the generated route information.

In this way, service route information for delivery which meets an intention of the client 3 is generated. As a result, delivery that meets an intention of the client 3 is performed by the secondary delivery server 80 (or a server handling the third and subsequent deliveries) that performs delivery on the basis of the service route information.

[Flow of Delivery Processing]

A flow of delivery processing performed by the secondary delivery server 80 is similar to the delivery processing performed by the secondary delivery server 2, which is illustrated in FIG. 7. However, the secondary delivery server 80 generates the service route information 62 and therefore, in S11 in FIG. 7, a delivery route may be determined by using the service route information 62 instead of the component management information 61. Alternatively, a delivery route may be determined by using the component management information without using the generated service route information 62.

Whether to use either one of the component management information 61 and the service route information 62 may be determined in advance or may be determined on the basis of the information contained in the service route information 62 as described above.

The secondary delivery server 80 transmits the service route information 62 together with the component 60 in the processing in S16 in FIG. 7. Note that, in this case, the component management information 61 may also be transmitted. However, delivery of the service route information 62 (and the component management information 61) is not essential. That is, in the case where it is obvious that the service route information 62 (and the component management information 61) will not be referred to in a subsequent delivery destination, delivery of the service route information 62 (and the component management information 61) may be omitted. A transmission destination of these pieces of data may be the client 3 or may be another delivery server (for example, a tertiary delivery server).

### Third Embodiment

Next, a third embodiment of the present invention will be described with reference to FIGS. 13 and 14. A delivery system according to this embodiment will be described first with reference to FIG. 13. FIG. 13 is a block diagram illustrating examples of configurations of a primary delivery server (association information generation device, delivery device) 90 and the client 3 that constitute a delivery system 6 according to this embodiment. Note that a configuration similar to that in the foregoing embodiments is given the same reference numeral and a description thereof will be omitted.

The delivery system 6 is different from the delivery system 5 of the foregoing embodiment in that the primary delivery servers 1, 1′, and 1″ are replaced by the primary delivery server 90. The primary delivery server 90 is a device constituted by integrating the primary delivery servers 1, 1′, and 1″ into one device.

Therefore, the primary delivery server 90 includes the medium generation unit 10, the formatting unit 11, and the route setting unit 12 included in the primary delivery server 1 as a first unit 14. Similarly, the primary delivery server 90 includes the medium generation unit 10′, the formatting unit 11′, and the route setting unit 12′ included in the primary delivery server 1′ as a second unit 14′, and includes the medium generation unit 10″, the formatting unit 11″, and the route setting unit 12″ included in the primary delivery server 1″ as a third unit 14″. Components and component management information generated by these units are stored in the storage unit 22. Here, component management information may be such that components that constitute content are brought together as illustrated in FIGS. 4 and 5.

The primary delivery server 90 includes a service design unit (secondary association information generation means) 15 and a selection unit (delivery control means, route determination means) 16 as in the secondary delivery server 80 of the foregoing embodiment. The service design unit 15 and the selection unit 16 have functions similar to those of the service design unit 53 and the selection unit 50 of the secondary delivery server 80. That is, the delivery system 6 of this embodiment is configured so that the primary delivery server 90 generates service route information.

Note that FIG. 13 illustrates an example in which delivery is performed from the primary delivery server 90 to the client 3 without a secondary delivery server. However, one or a plurality of delivery servers may act as an intermediary between the primary delivery server 90 and the client 3.

[Configuration of Primary Delivery Server 90]

Next, a more detailed configuration of the primary delivery server 90 will be described with reference to FIG. 14. FIG. 14 is a block diagram illustrating an example of a configuration of a principal part of the primary delivery server 90. As illustrated, the primary delivery server 90 includes the first transmission unit 20, the second transmission unit 20′, the third transmission unit 20″, the control unit 21, and the storage unit 22.

The control unit 21 includes the first unit 14, the second unit 14″, the third unit 14″, the service design unit 15, and the selection unit 16. Note that the second unit 14′ includes the medium generation unit 10′, the formatting unit 11′, and the route setting unit 12′ as in the first unit 14, however, configurations of these units are not illustrated. The same applies to the third unit 14″. The selection unit 16 includes a delivery control unit and a route determination unit as in the selection unit 51 (see FIG. 1), however, configurations of these unit are not illustrated, either.

In the primary delivery server 90, components generated by the first unit 14, second unit 14′, and third unit 14″ are stored in the storage unit 22 as the components 30. Component management information generated by the first unit 14, second unit 14′, and third unit 14″ are stored in the storage unit 22 as the component management information 31.

In the case where the component management information 31 is generated in which pieces of route information for components that constitute one piece of content are brought together as illustrated in FIGS. 4 and 5, a configuration may be added in which processing of integrating pieces of component management information generated by the units is performed.

In the primary delivery server 90, the service design unit 15 generates service route information on the basis of the component management information 31 and stores the service route information in the storage unit 22 as service route information 32.

Here, the service design unit 15 may generate a plurality of pieces of service route information 32 that respectively correspond to the types of secondary distributors (secondary delivery servers). For example, the service design unit 15 may generate the service route information 32 mainly based on route information that indicates a broadcast route, for a broadcaster, and may generate the service route information 32 mainly based on route information that indicates a communication route, for a telecommunication carrier.

When the service design unit 15 generates the service route information 32 for another server, the service design unit 15 need not refer to the component management information 31. In this case, a content creator or the like may set each piece of route information contained in the service route information 32.

The selection unit 16 determines a delivery route of each component 30 by referring to the component management information 31, and delivers each component 30 from a transmission unit (any of the first transmission unit 20, second transmission unit 20′, and third transmission unit 20″) which corresponds to the determined delivery route. The selection unit 16 may determine a delivery route that is appropriate to the connection state or the like at the time of the first delivery, by referring to the service route information 32. In the case where the delivery destination is a secondary delivery server or the like that has been determined in advance, the selection unit 16 may determine a delivery route that is available for delivery to the server without referring to either one of the component management information 31 and service route information 32.

The selection unit 16 also performs delivery of the service route information 32. As a result, a secondary delivery server or the like that has received the service route information 32 is able to perform redelivery using an appropriate delivery route based on the service route information 32. Note that the selection unit 16 may also deliver the component management information 31. This can expand the range of choices of delivery routes available to a secondary server or the like.

[Processing Performed by Primary Delivery Server 90] The primary delivery server 90 generates the component management information 31 by performing the component management information generation processing (see FIG. 6). The details of the component management information generation processing are substantially the same as described in the first embodiment. However, the primary delivery server 90 is different from the primary delivery servers 1, 1′, and 1″ in that the primary delivery server 90 directly performs delivery to the client 3. Accordingly, in S2 in FIG. 6, the route determination units 12, 12′, and 12″ respectively determine pieces of route information indicating delivery routes used by the first transmission unit 20, second transmission unit 20′, and third transmission unit 20″ respectively, automatically or on the basis of an input operation performed by a user (a medium creator or the like).

The primary delivery server 90 generates the service route information 32 by performing the service route information generation processing (see FIG. 12). The primary delivery server 90 then delivers a component by performing the delivery processing (see FIG. 7). These pieces of processing are as described in the foregoing embodiment and therefore descriptions thereof will be omitted here.

[Use of Bidirectional Delivery Route]

As described above, the component management information and service route information are used for a delivery server to select a delivery route appropriate to a component, however, the component management information and service route information may also be used in order to communicate the presence of a component to a client.

In the case where a delivery route that has been selected for a component is a delivery route used for bidirectional delivery, delivery of the component will be performed when delivery is requested from a client. That is, in the case where a bidirectional delivery route is used, it is necessary to communicate to the client the presence of a component to be delivered using a bidirectional delivery route and make the client transmit a request for the component.

The foregoing component management information and service route information can be used for such communication. That is, by transmitting the component management information or service route information to a client, the client is able to identify the way in which the component is to be delivered. Then, for the component that has been identified to be delivered by means of bidirectional delivery, the client is able to acquire the component by making a transmission request. In this case, it is necessary to make the client identify a transmission request destination and therefore information (URL or the like) used to identify the request destination is also delivered to the client.

### Fourth Embodiment

As described in the third embodiment, in order for a client to receive components delivered via various routes and to replay them appropriately, information (hereinafter referred to as acquisition source information) regarding an acquisition source which indicates the URL, channel, or the like of each component is necessary.

Such acquisition source information is usually transmitted from a server to a client as part of the component management information, which has been indicated in the description of FIG. 4(b) in the first embodiment. That is, in the component management information in FIG. 4(b), acquisition source information is described in the omitted portion (the portion of “ . . . ”) in each <component> element and is transmitted from the server to the client.

The route information of the present invention contained in the component management information, which has been described in the first to third embodiments, is information used by a sender (for example, a server). On the other hand, the acquisition source information is information used by a receiver (for example, a client). However, the value of acquisition source information for a component is basically determined by reflecting the route information (the value is set by a server). Although route information and acquisition source information have different generation timings and use timings, they are related to each other.

In a fourth embodiment, the ways, in delivery systems, of generation, modification, and use of route information and acquisition source information contained in component management information will be described with reference to FIG. 16.

FIG. 16 includes block diagrams schematically illustrating delivery systems according to this embodiment. FIG. 16(a) illustrates an example without a relay server, and FIG. 16(b) illustrates an example including a relay server. In FIGS. 16(a) and 16 (b), relationships between components and pieces of component management information transmitted in the delivery systems are also illustrated.

[Configuration of Delivery System without Relay Server]

First, a configuration of a delivery system in FIG. 16(a) which does not include a relay server will be described. A delivery system illustrated in FIG. 16(a) includes a content provider server 131, a service provider server 132, and a client 133.

The content provider server 131 is a delivery server managed by a content creator. As illustrated, the content provider server 131 is a delivery device that delivers components to the service provider server 132 by using a plurality of delivery routes. Each of the primary delivery servers 1 to 1″ illustrated in FIG. 2 of the first embodiment and FIG. 10 of the second embodiment corresponds to the content provider server 131.

The service provider server 132 is a server managed by a delivery service operator. As illustrated, the service provider server 132 delivers components received from the content provider server 131 to the client 133 by using a plurality of delivery routes. That is, the service provider server 132 has the function of a delivery device. Each of the secondary delivery servers 2 and 80 respectively illustrated in FIG. 2 of the first embodiment and FIG. 10 of the second embodiment corresponds to the service provider server 132.

The client 133 is a terminal that receives components last and replays the content. As illustrated, the client 133 receives components from the service provider server 132 via a plurality of delivery routes. The client 3 in the foregoing embodiments corresponds to the client 133.

[Flow of Processing Performed in Delivery System without Relay Server]

Next, a flow of processing in the delivery system without a relay server will be described with reference to FIG. 16(a).

First, the content provider server 131 (content creator) generates components of content and also generates pieces of route information that indicate appropriate routes used for delivery of the components. Generation of route information is as described in the foregoing embodiments.

Then, the content provider server 131 transmits the generated pieces of route information to the service provider server 132. Specifically, the content provider server 131 transmits component management information 91 that contains the generated pieces of route information to the service provider server 132.

As illustrated, in the management information 91, route information “unicast” indicating that a component “compA” is a component for unicast delivery and route information “broadcast” indicating that a component “compB” is a component for broadcasting are described. As described above, these pieces of route information are used for the service provider server 132 (delivery service operator) to determine acquisition source information.

Next, the service provider server 132 (delivery service operator) specifically determines a route used to transmit each component, by referring to the route information contained in the management information 91 received from the content provider server 131. The service provider server 132 then generates acquisition source information used to communicate the determined route to the client 133. That is, the service provider server 132 includes acquisition source information generation means for generating acquisition source information.

The acquisition source information is information used in order for the client 133 to acquire each component. Therefore, the service provider server 132 describes the acquisition source information that has been generated in component management information 91′ and delivers the component management information 91′ to the client 133. That is, the service provider server 132 includes acquisition source information delivery means. Note that acquisition source information may be delivered as data separated from the component management information 91′.

As illustrated, in the component management information 91′ transmitted to the client 133, route information “unicast” indicating that the component “compA” is for unicast delivery is described together with acquisition source information “url-a1” (a communication URL of the acquisition source) indicating the specific acquisition source of the component. In addition, route information “broadcast” indicating that the component “compB” is a component for broadcasting is described together with acquisition source information “ch-b1” (information regarding the acquisition source, which indicates the broadcasting station and channel of the acquisition source) indicating the specific acquisition source of the component.

The client 133 that has received such component management information 91′ is able to acquire desired components by referring to the acquisition source information. That is, in order to acquire the component “compA”, the client 133 may access the acquisition source indicated by the acquisition source information “url-a1”. Similarly, in order to acquire the component “compB”, the client 133 may tune its reception channel to the acquisition source indicated by the acquisition source information “ch-b1”. As a result, the client 133 is able to acquire components using delivery routes in accordance with the route information.

[Configuration of Delivery System Including Relay Server]

Next, a configuration of a delivery system in FIG. 16(b) which includes a relay server will be described. A delivery system illustrated in FIG. 16(b) is different from the delivery system in FIG. 16(a) in that the delivery system in FIG. 16(b) includes a relay server 142 between the service provider server 132 and the client 133.

The relay server 142 is a server that performs relay for content delivery. The relay server 142 may be a proxy server or a mirror server used for transfer, for example, or may be a server or the like managed by another delivery service operator. That is, the relay server 142 also has the function of a delivery device.

As illustrated, the relay server 142 delivers components received from the service provider server 132 to the client 133 by using a plurality of delivery routes. Note that the relay server 142 may receive components from the content provider server 131. A delivery destination of components to be delivered by the relay server 142 may be another relay server that is not illustrated.

It is assumed that the relay server 142 has a function of accumulating components delivered from the service provider server 132 or the content provider server 131 therein or in another apparatus and transferring the components to a subsequent relay server or the client 133.

[Flow of Processing Performed in Delivery System Including Relay Server]

Processing performed in the delivery system including the relay server is similar to that in the example of FIG. 16(a) up to the process in which the service provider server 132 generates the component management information 91′ that contains route information and acquisition source information. However, the delivery system in FIG. 16(b) is different from that in FIG. 16(a) in that the component management information 91′ is transmitted to the relay server 142.

Here, route information has been determined on the basis of the characteristics or the like of the medium and therefore basically no modification needs to be made even if the relay server 142 is involved in the processing. On the other hand, acquisition source information of the component needs to be modified so as to indicate an accumulation source in the relay server 142 in the case where the relay server 142 is involved in the processing.

Accordingly, the relay server 142 generates component management information 91″ by taking only route information from the component management information 91′ obtained from the service provider server 132. As illustrated, in the component management information 91″, acquisition source information (other device acquisition source information) described in the component management information 91′ is not described but route information of each component taken from the component management information 91′ is described.

The relay server 142 newly generates acquisition source information by referring to the route information that has been taken. That is, the relay server 142 includes acquisition source information generation means for generating acquisition source information. The relay server 142 generates component management information 91′″ generated from the component management information 91″ by describing the newly generated acquisition source information in the component management information 91′″, and delivers the generated component management information 91′″ to a subsequent relay server or the client 133. That is, the relay server 142 includes acquisition source information delivery means.

As illustrated, in the component management information 91′″ transmitted from the relay server 142, route information “unicast” indicating that the component “compA” is a component for unicast delivery is described together with new acquisition source information “url-a2” indicating the specific acquisition source of the component. In addition, route information “broadcast” indicating that the component “compB” is a component for broadcasting is described together with new acquisition source information “ch-b2” indicating the specific acquisition source of the component.

The client 133 that has received such component management information 91′″ is able to acquire desired components by referring to the acquisition source information. That is, in order to acquire the component “compA”, the client 133 may access the acquisition source indicated by the acquisition source information “url-a2”. Similarly, in order to acquire the component “compB”, the client 133 may tune its reception channel to the acquisition source indicated by the acquisition source information “ch-b2”. As a result, the client 133 is able to acquire the components from the relay server 142.

Note that the example of FIG. 16(a) is an example in which the service provider server 132 generates component management information in which acquisition source information is described, however, it is possible to make the content provider server 131 in FIG. 16(a) perform similar processing. Alternatively, it is possible to make the relay server 142 in FIG. 16(b) perform similar processing (make the relay server 142 newly generate component management information).

In the example of FIG. 16(b), the content provider server 131 may be configured to generate component management information in which acquisition source information is described. In this case, the service provider server 132 may generate component management information (corresponding to the component management information 91′″ in FIG. 16(b)) in which acquisition source information has been updated.

The examples of FIGS. 16(a) and 16(b) each illustrate a form in which one delivery system includes one of each of the plurality of types of servers, and one server performs delivery using a plurality of routes. However, as already described in the first and second embodiments, delivery may be performed by a plurality of servers using a plurality of routes. That is, a delivery system is constituted by a plurality of content provider servers 131 and/or service provider servers 132, and delivery of components may be performed by the plurality of servers using a plurality of routes. The same applies to the relay server 142.

The examples of FIGS. 16(a) and 16(b) illustrate a case of two components, “compA” and “compB”. However, the number of components described in component management information is not limited to such examples. The examples of FIGS. 16(a) and 16(b) illustrate cases where components include a component for unicast delivery and a component for broadcasting. However, needless to say, route information for components is not limited to such examples.

For example, three components may be components to be delivered, and one may be for broadcasting and the remaining two may be for unicast. Alternatively, four components may be components to be delivered, and one may be for broadcasting, one may be for multicast delivery, and the remaining two may be for unicast delivery. In any of the foregoing cases, management using component management information as described above can be performed. In this way, the delivery systems of the present invention are applicable to various numbers of components and various patterns of route information. As a matter of course, the case of one component is covered by the delivery systems of the present invention.

[Modification of Route Information]

The examples of FIGS. 16(a) and 16(b) illustrate a case where route information set by the content provider server 131 (content creator) is passed throughout the delivery system. As described in the first embodiment, passing of route information has an effect of making an intention of a content creator clearly reflected in delivery.

However, as already described in the second embodiment, it is possible for the service provider server 132 and/or a subsequent service provider to modify route information in accordance with the service provided thereby or delivery routes owned thereby.

In this case, as described in the second embodiment, it is possible to form and manage service route information separately from component management information, or modify component management information itself and transmit it to the subsequent relay server 142 or client 133.

[Component Management Information in which a Plurality of Pieces of Route Information (Acquisition Source Information) are Described]

Furthermore, it is also possible to allow a plurality of pieces of route information to be described for one component in component management information, and to make an apparatus (the service provider server 132, the relay server 142, or the like) involved in delivery of components additionally describe route information. Similarly, it is also possible to allow a plurality of pieces of acquisition source information to be described for one piece of route information, and to make an apparatus (the service provider server 132, the relay server 142, or the like) involved in delivery of components additionally describe acquisition source information.

The foregoing case will be described with reference to FIG. 17. FIG. 17 includes diagrams illustrating examples of component management information in which a plurality of pieces of route information can be described for one component and an example of component management information in which a plurality of pieces of route information can be described for one piece of route information.

Specifically, FIG. 17(a) illustrates an example of component management information in which two pieces of route information are described for one component, and FIG. 17(b) illustrates an example of component management information in which acquisition source information is described for each of two pieces of route information. FIG. 17(c) illustrates an example of component management information in which two pieces of acquisition source information are described for one piece of route information. Note that component management information generated by the content provider server 131 is basically used and therefore the examples illustrated in FIGS. 17(a) to 17(c) in which component management information is modified is considered to be a special case.

In the component management information in FIG. 17(a), a plurality of pieces of route information can be described for one component. Specifically, a piece of route information “broadcast” is associated with a component “compB” and described, and “unicast” is also associated with the component “compB” and described as a second piece of route information.

The first piece of route information is described by the content provider server 131 in FIG. 16(b), for example, and the second piece of route information is described by the relay server 142, for example. In this case, the relay server 142 that has received the component management information 91′ from the service provider server 132 determines that the component “compB” can also be delivered by means of unicast. The relay server 142 then generates the component management information in FIG. 17(a) instead of the component management information 91″ in FIG. 16(b). That is, the relay server 142 includes association information update means for further associating a piece of route information with a component with which another piece of route information has been associated, in the received component management information.

The relay server 142 determines a route used when delivering the component “compB” by means of unicast, and generates acquisition source information in accordance with the determined delivery route. The relay server 142 describes the generated acquisition source information by associating it with the component “compB”, and generates the component management information in FIG. 17(b). This component management information is delivered to a subsequent relay server or the client 133 instead of the component management information 91′″ in FIG. 16(b).

The additional description of route information as described above can be performed by any apparatus that performs delivery of a component to the client 133, and may be performed by the service provider server 132, for example.

In the example of FIG. 17(b), two pieces of route information are described for the component “compB”, and a piece of acquisition source information is described for each piece of route information. Accordingly, the client 133 that has received such component management information is able to acquire the component “compB” by using a piece of acquisition source information corresponding to any of the pieces of route information.

That is, the client 133 is able to receive the component “compB” using a channel indicated by the piece of acquisition source information “ch-b2”, or is able to receive the component “compB” by accessing a URL indicated by the piece of acquisition source information “url-b2”.

As described above, the range of choices of acquisition routes for a component in the client 133 can be expanded by generating component management information in which a piece of route information is additionally described. Furthermore, in the case where a component cannot be acquired using one of the routes, it becomes possible to acquire the component using any other route.

As a matter of course, the number of routes associated with one component and the values of pieces of route information in component management information are not limited to the examples of FIGS. 17(a) and 17(b), and various patterns are applicable.

In the component management information in FIG. 17(c), a plurality of pieces of acquisition source information are allowed to be described for one piece of route information. Specifically, two pieces of acquisition source information, “url-a1” and “url-a2” are associated with a piece of route information “unicast” and described, “unicast” being associated with a component “compA” and described.

Such component management information is generated by the relay server 142 in FIG. 16(b), for example. In this case, the relay server 142 generates a new piece of acquisition source information “url-a2” used to deliver the component “compA” from the relay server 142 by means of unicast delivery, on the basis of route information in the received component management information 91′. The relay server 142 additionally describes this new piece of acquisition source information so that the new piece of acquisition source information and the original piece of acquisition source information “url-a1” (other device acquisition source information) coexist, and generates the component management information in FIG. 17(c). The generated component management information is delivered to a subsequent server or the client 133 instead of the component management information 91′″ in FIG. 16(b).

The client 133 that has received such component management information acquires the component “compA” by using any of the pieces of acquisition source information. That is, the client 133 selects an appropriate one from among the pieces of acquisition source information, “url-a1” and “url-a2”, accesses the selected URL, and acquires the component “compA”.

As a matter of course, the number of pieces of acquisition source information associated with one piece of route information and the values of such pieces of acquisition source information in component management information are not limited to the example of FIG. 17(c), and various patterns are applicable.

The present invention is not limited to the foregoing embodiments. Various modifications can be made within the scope of claims, and any embodiment obtained by appropriately combining technical means respectively disclosed in different embodiments is also included in the technical scope of the present invention.

[Example of Configuration by Means of Software]

Lastly, the blocks of the primary delivery servers 1 and 90 and the secondary delivery servers 2 and 80, especially the control units 21 and 43, may be implemented by means of hardware using a logic circuit formed on an integrated circuit (IC chip), or may be implemented by means of software using a CPU (Central Processing Unit). The same applies to the acquisition source information generation means, acquisition source information delivery means, and association information update means included in the service provider server 132 and/or the relay server 142.

In the latter case, the primary delivery servers 1 and 90 and the secondary delivery servers 2 and 80 each include a CPU that executes instructions of a program that implements the functions, a ROM (Read Only Memory) that stores the program, a RAM (Random Access Memory) in which the program runs, a storage device (recording medium), such as a memory, that stores the program and various types of data, and the like. An object of the present invention can be achieved by supplying, to the primary delivery servers 1 and 90 and the secondary delivery servers 2 and 80, a recording medium in which a program code (a program in an executable form, an intermediate code program, or a source program) of the control program of the primary delivery servers 1 and 90 and the secondary delivery servers 2 and 80, the control program being software used to implement the foregoing functions, is recorded so as to be readable by a computer, and by making the computer (or a CPU or an MPU) read and execute the program code recorded in the recording medium.

Examples of the recording medium includes tapes, such as a magnetic tape and a cassette tape, disks including magnetic disks, such as a floppy (registered trade mark) disk and a hard disk, and optical disks, such as a CD-ROM, an MO, an MD, a DVD, and a CD-R, cards, such as an IC card (including a memory card) and an optical card, semiconductor memories, such as a mask ROM, an EPROM, an EEPROM (registered trade mark), and a flash ROM, logic circuits, such as a PLD (Programmable Logic Device) and an FPGA (Field Programmable Gate Array), and the like.

The primary delivery servers 1 and 90 and the secondary delivery servers 2 and 80 may be configured so as to be connectable to a communication network, and the program code may be supplied thereto over the communication network. Such a communication network may be any communication network that allows transmission of the program code, and is not limited to a specific communication network. For example, the Internet, an intranet, an extranet, a LAN, an ISDN, a VAN, a CATV communication network, a virtual private network, a telephone circuit network, a mobile communication network, a satellite communication network, or the like can be used. Furthermore, a transmission medium that constitutes such a communication network may be any medium that allows transmission of the program code, and is not limited to a medium having a specific configuration or a medium of a specific type. Examples of a transmission medium that can be used include transmission media based on wired techniques, such as IEEE1394, USB, a power line carrier, a cable TV circuit, a telephone line, and an ADSL (Asymmetric Digital Subscriber Line) circuit, and transmission media based on wireless techniques, such as IrDA, a remote controller or other types of infrared, Bluetooth (registered trade mark), IEEE802.11 radio, HDR (High Data Rate), NFC (Near Field Communication), DLNA (Digital Living Network Alliance), a mobile phone network, a satellite circuit, and a terrestrial digital network. Note that the present invention can be achieved in a form of computer data signals put in carriers, the computer data signals being one form of the program code which is implemented by means of electronic transmission.

[Examples of Route Information]

Examples of route information based on information that specifies a delivery route in terms of functionality will be described, in relation to [Other Examples] in the first embodiment.

Among pieces of information that specify delivery routes in terms of functionality, examples of route information that indicates immediacy include information indicating delay tolerance of a component, such as “delay#priority”. “delay#priority” (priority level regarding delay) is an indicator that indicates to what degree a delay during transmission is allowed when a component is to be transmitted, and it is assumed that “delay#priority” has indicator levels, such as a “level 3 (“11” when expressed in binary): high sensitivity: end-to-end delay <<1 sec“, a “level 2 (“10”): medium sensitivity: end-to-end delay approx. 1 sec“, a “level 1 (“01”): low sensitivity: end-to-end delay <5-10 sec“, and a “level 0 (“00”): don't care“. In this case, a component for which no delay is allowed, that is, a component having extremely low delay tolerance, is assigned the level 3, and is transmitted using a broadcast route with no delay, for example. A component for which a substantial delay is allowed (a delay of 10 seconds or more is allowed, or a delay is not taken into consideration at all), that is, a component having a high delay tolerance, is assigned the level 0, and is transmitted using an open Internet route based on a best effort scheme, for example.

Among pieces of information that specify delivery routes in terms of functionality, examples of route information that indicates responsiveness include “response#priority”. “response#priority” (priority level regarding response) is an indicator that indicates an allowance for a delay in relation to a response, and it is assumed that “response#priority” has indicator levels similar to those of the foregoing delay#priority. response#priority is used together with the route information “bidirectional” that indicates bidirectional delivery, which has been described.

Among pieces of information that specify delivery routes in terms of functionality, examples of route information that indicates high reliability include information indicating error resilience of a component, such as “loss#priority”, and information indicating delay tolerance of a component, such as “delay#priority”. “loss#priority” (priority level regarding loss) is an indicator that indicates to what degree loss during transmission is allowed when a component is to be transmitted, and it is assumed that “loss#priority” has indicator levels, such as a “level 3 (“11” when expressed in binary): loss priority 0 (lossless), a “level 2 (“10”): loss priority 1 (lossy, high priority)“, a “level 1 (“01”): loss priority 2 (lossy, medium priority)“, and a “level 0 (“00”): loss priority 3 (lossy, low priority)“. In this case, a component for which no loss is allowed, that is, a component having extremely low error resilience is assigned the level 3, and is transmitted using a unicast communication route on which substantially no loss occurs using a retransmission request or the like, for example. A lossless delivery route is interpreted as a delivery route having high reliability. A component having error resilience for which loss is allowed is assigned one of the levels 2 to 0 depending on the degree of error resilience, and is transmitted by means of multicast communication, by using a broadcast route, or the like. “delay#priority” (priority level regarding delay) that has already been described can also be interpreted as route information indicating high reliability. It is assumed that “delay#priority” has indicator levels, such as a “level 3 (“11”): high sensitivity: end-to-end delay <<1 sec“, a “level 2 (“10”): medium sensitivity: end-to-end delay approx. 1 sec“, a “level 1 (“01”): low sensitivity: end-to-end delay <5-10 sec“, and a “level 0 (“00”): don't care)“. Then, a route with a less delay is interpreted as a route having high reliability, and is assigned a level having a higher value.

As route information indicating high reliability, either one of the information indicating error resilience of a component and the information indicating delay tolerance of a component may be selected and used, or both of them may be selected, combined, and used.

Here, an example will be described in which either one of the information indicating error resilience of a component and the information indicating delay tolerance of a component is selected and used, as route information indicating high reliability. For example, in the case where route information indicating high reliability is loss#priority having the priority level “11: loss priority 0 (lossless)”, it is determined that it is appropriate to deliver the component using a lossless route. In this case, if an available delivery route is either one of a broadcast route and a communication route, it can be considered that loss#priority having the priority level “11” corresponds to route information directly indicating that the component is for broadband delivery using a communication route, which is “broadband”, for example. For example, in the case where route information indicating high reliability is delay#priority having the priority level “11: high sensitivity: end-to-end delay <<1 sec”, it is determined that it is appropriate to deliver the component using a route with no delay. In this case, if an available delivery route is either one of a unicast delivery route and a multicast delivery route, it can be considered that delay#priority having the priority level “11” corresponds to route information indicating that the component is for multicast delivery requiring less processing for a request and a response, which is “multicast”, for example.

FIG. 19 illustrates an example of a delivery route that should be selected, in the case where both of the information indicating error resilience of a component and the information indicating delay tolerance of a component are selected, combined, and used, in accordance with the combination. FIG. 19 is illustrated while the axes respectively represent the value of the priority level of loss#priority (priority level regarding loss) and the value of the priority level of delay#priority (priority level regarding delay), which have been already described. That is, the axis of error resilience represents the allowance for errors such that the allowance becomes smaller as the value becomes larger and the allowance becomes larger as the value becomes smaller. The axis of delay tolerance represents the allowance for a delay such that the allowance becomes smaller as the value becomes larger and the allowance becomes larger as the value becomes smaller. For example, in the case where loss#priority having the priority level “11: loss priority 0 (lossless)” and delay#priority having the priority level “00: don't care” are selected and combined as the information indicating error resilience of a component and the information indicating delay tolerance of a component respectively, it can be considered that the combination of these pieces of information corresponds to route information (for example, “unicast”) indicating that the component is for unicast delivery. For example, in the case where loss#priority having the priority level “00: loss priority 3” and delay#priority having the priority level “11: high sensitivity: end-to-end delay” are selected and combined, it can be considered that the combination of these pieces of information corresponds to route information (for example, “broadcast”) indicating that the component is for broadcast delivery.

Furthermore, it is possible to use request information regarding a form of delivery of a component, which specifies how a component is delivered, as information used for route selection, that is, the route information of the present invention. Specific examples of request information regarding a form of delivery may include information that indicates simultaneity, real-timeliness, or the like.

Among pieces of request information regarding a form of delivery, examples of route information indicating simultaneity include information indicating that a component is for simultaneous delivery, that is, “simultaneity#priority”. “simultaneity#priority” (priority level regarding simultaneity) is an indicator that indicates whether or not the component is a component that is to be simultaneously delivered to an unspecified large number of clients, and it is assumed that “simultaneity#priority” has indicator levels, such as a “level 3 (“11” when expressed in binary): priority 0 (simultaneous, many and unspecified), a “level 2 (“10”): priority 1 (simultaneous, small and unspecified)“, a “level 1 (“01”): priority 2 (simultaneous, small and specified)“, and a “level 0 (“00”): priority 3 (single)“. In this case, a component that is to be simultaneously delivered to an unspecified large number of clients is assigned the level 3, and is delivered using a broadcast route, for example. A component that is to be delivered to a client on a one-on-one basis is assigned the level 0, and is delivered by means of unicast delivery using a communication route.

Among pieces of request information regarding a form of delivery, examples of route information indicating real-timeliness may include information regarding delivery latency indicating the time from when a component is generated (an image of a component is captured or sound of a component is recorded) until when the component is actually delivered, that is, “live#priority”. “live#priority” (priority level regarding real-timeliness) is an indicator that indicates to what degree a delivery delay is allowed while the time from when a component is generated until when the component is delivered is considered to be a delay in delivery, and it is assumed that “live#priority” has indicator levels, such as a “level 1: priority 0 (immediate)” and a “level 0: priority 1 (don't care)”, for example. In this case, a component that requires real-timeliness, that is, a component that should be immediately delivered upon generation is assigned the level 1, and is immediately delivered using a communication route that enables real-time delivery. A component that does not require real-timeliness is assigned the level 0, and is allowed to be delivered using a broadcast route at an appropriate time.

Route information that indicates a delivery route in terms of functionality and route information that is request information regarding a form of delivery are described in component management information. The selection unit or the route determination unit appropriately selects and determines a delivery route actually used for a component by combining these pieces of information. For example, component management information for a component “compA” is described as follows in which pieces of route information indicating immediacy, real-timeliness, simultaneity, and unidirectionality/bidirectionality among various pieces of route information are described.

```
<component name=“compA”
    delay#priority=“3”
    live#pliority=“3”
    simultaneity#priority=“0”
    trans=“bidirectional”
    ... />
```

### CONCLUSION

As described above, the delivery device described in the present description is a delivery device that delivers content constituted by a plurality of components. The delivery device includes route determination means for determining, by using association information in which pieces of route information used to identify delivery routes of the components are associated with the components, a delivery route of each of the components, and delivery control means for delivering each of the components using the delivery route determined by the route determination means.

The delivery method described in the present description is a delivery method performed by a delivery device that delivers content constituted by a plurality of components. The delivery method includes a route determination step of determining, by using association information in which pieces of route information used to identify delivery routes of the components are associated with the components, a delivery route of each of the components, and a delivery control step of delivering each of the components using the delivery route determined in the route determination step.

With the foregoing configuration, a delivery route of each component is determined by using association information in which route information used to identify a delivery route of each component is associated with the component, and the component is delivered using the determined delivery route.

Accordingly, with the foregoing configuration, it is not necessary to perform an analysis or the like of the contents of a component in order to determine a delivery route, and a delivery route of each component that constitutes part of content can be easily determined and the component can be easily delivered.

Note that the foregoing association information may be in a form in which route information is associated with the component itself (for example, a header of the component), or may be information managed separately from the component (for example, information in a table format or in an XML format).

The foregoing route information may be any information that can be used to identify a delivery route of a component. For example, the route information may be information that directly indicates a specific delivery route (a broadcast route, a communication route, or the like), or may be information that indicates the characteristics (bidirectional, unidirectional, multicast, unicast, or the like) of a delivery route. Furthermore, the route information may be information indicating that delivery using a specific delivery route is permitted (recommended) or prohibited.

Note that the foregoing component constitutes part of a piece of content, and is a component part that can be delivered using a different route from those of other component parts. For example, video data and audio data that constitute one piece of animation content can be delivered using different routes respectively and therefore each of the video data and audio data can be the foregoing component.

It is preferable that the delivery device described in the present description further include a reception unit that receives the components and the association information. It is preferable that the route determination means determine delivery routes of the respective components received by the reception unit by using the association information received by the reception unit, and that the delivery control means deliver the components received by the reception unit using the respective delivery routes determined by the route determination means.

With the foregoing configuration, a reception unit that receives the components and the association information is further included, delivery routes of the respective components received by the reception unit are determined by using the association information received by the reception unit, and the components received by the reception unit are delivered using the respective determined delivery routes.

That is, with the foregoing configuration, a component received from a device is further redelivered to another device. When a component is retransmitted, a delivery route is determined using received association information. Therefore, with the foregoing configuration, redelivery of a component using an appropriate delivery route in accordance with association information is possible.

It is preferable that, in the association information, route information be associated with a group constituted by a plurality of components, and that the route determination means determine a delivery route of each component belonging to the same group by using route information associated with the group.

With the foregoing configuration, in the association information, route information is associated with a group constituted by a plurality of components, and a delivery route of each component belonging to the same group is determined by using route information associated with the group.

Therefore, components can be easily delivered in a group. Note that a group constituted by a plurality of components may be a group constituted by a plurality of separate components or may be a group formed by multiplexing a plurality of components. In the case where a group is constituted by a plurality of separate components, the components may be delivered after the components have been multiplexed.

It is preferable that the delivery device described in the present description further include secondary association information generation means for generating secondary association information different from the association information by associating route information with each of the components.

With the foregoing configuration, secondary association information different from the association information is generated by associating route information with each component. As a result, two pieces of information, that is, association information and secondary association information will be generated as information used to determine a delivery route of a component.

Therefore, with the foregoing configuration, the variety of delivery routes for components is increased. As a result, it also becomes possible to make each delivery operator using the delivery device perform delivery using an appropriate delivery route in accordance with its delivery capability, for example.

It is preferable that the secondary association information generation means generate the secondary association information by replacing a piece of route information indicating a delivery route that the delivery device is unable to use, among the pieces of route information contained in the association information, with a delivery route that the delivery device is able to use.

Here, in the case where the delivery device described in the present description is used for the second delivery of content, it is assumed that delivery using a delivery route indicated by route information in the association information may be difficult. For example, in the case where the delivery device described in the present description only supports broadcast delivery, even if route information specifying a communication route is associated with a component, the component cannot be delivered using a communication route. Even in the case where the delivery device supports communication delivery, if network traffic between the delivery device and a client is high, delivery using a communication route will become difficult.

With the foregoing configuration, the secondary association information is generated by replacing a piece of route information indicating a delivery route that the delivery device is unable to use, among the pieces of route information contained in the association information, with a delivery route that the delivery device is able to use.

Therefore, by performing delivery using secondary association information generated as described above, it becomes possible to perform delivery using an appropriate delivery route on the basis of the original association information and in accordance with the delivery capability of the delivery device, the congestion state of a delivery route, and the like.

Furthermore, such secondary association information may be transmitted to another delivery device. As a result, it is possible to make another delivery device having a delivery capability similar to that of the delivery device or another delivery device in a communication environment similar to that of the delivery device perform delivery using an appropriate delivery route.

It is preferable that the delivery device described in the present description further include a reception unit that receives the components and the association information, and association information update means for further associating additional route information with a component with which route information has been associated in the association information received by the reception unit.

With the foregoing configuration, additional route information is further associated with a component with which route information has been associated in the association information received by the reception unit. That is, a plurality of pieces of route information are associated with one component. Consequently, with the foregoing configuration, the range of choices of delivery routes for a component can be expanded.

It is preferable that the delivery device described in the present description further include a reception unit that receives the components and the association information, acquisition source information generation means for generating acquisition source information used to acquire the components using delivery routes determined by the delivery route determination means, and acquisition source information delivery means for delivering the acquisition source information generated by the acquisition source information generation means.

With the foregoing configuration, acquisition source information used to acquire the components using delivery routes determined by the delivery route determination means is generated, and the acquisition source information is delivered. Note that acquisition source information may be delivered with association information by additionally describing the acquisition source information in the association information.

Therefore, a device that has received delivery of the acquisition source information can acquire a component using a delivery route determined by the route determination means, by referring to the acquisition source information. That is, with the foregoing configuration, it is possible to make a client acquire a component in accordance with association information.

It is preferable that the acquisition source information generation means generate, in the case where the reception unit has received the components and other device acquisition source information used to acquire the components from another device, acquisition source information used to acquire the components from the delivery device.

With the foregoing configuration, in the case where the components and other device acquisition source information used to acquire the components from another device have been received, acquisition source information used to acquire the components using delivery routes determined by the delivery route determination means is generated.

That is, with the foregoing configuration, it is possible to make a client acquire the component using a delivery route determined by the route determination means. As a result, it becomes possible to make a client acquire the component even in the case where the component cannot be acquired from an acquisition source indicated by other device acquisition source information.

The acquisition source information generation means may be such that it generates, in the case where the reception unit has received the components and other device acquisition source information used to acquire the components from another device, acquisition source information used to acquire the components from an acquisition source indicated by the received other device acquisition source information or by using delivery routes determined by the delivery route determination means.

With the foregoing configuration, in the case where components and other device acquisition source information have been received, acquisition source information used to acquire the components from an acquisition source indicated by the received other device acquisition source information or by using delivery routes determined by the delivery route determination means is generated.

Therefore, it is possible to make a client acquire the components from an acquisition source indicated by other device acquisition source information or using delivery routes determined by the route determination means. This can give a client choices of routes used to acquire components. Furthermore, even in the case where the components cannot be acquired from either of the acquisition source indicated by other device acquisition source information and the delivery routes determined by the route determination means, it becomes possible to make a client acquire the components.

The association information generation device described in the present description includes route information determination means for determining, for components constituting content, pieces of route information used to identify delivery routes of the components, and association information generation means for generating association information by associating the pieces of route information determined by the route information determination means with the components.

The association information generation method described in the present description is an association information generation method performed by an association information generation device. The association information generation method includes a route information determination step of determining, for components constituting content, pieces of route information used to identify delivery routes of the components, and an association information generation step of generating association information by associating the pieces of route information determined in the route information determination step with the components.

With the foregoing configuration, for components constituting content, pieces of route information used to identify delivery routes of the components are determined, and association information is generated by associating the determined pieces of route information with the components.

Therefore, by using the association information, it is not necessary to perform an analysis or the like of the contents of a component in order to determine a delivery route, and a delivery route of each component that constitutes part of content can be easily determined and the component can be easily delivered.

Note that a device that performs delivery by using the generated association information may be the association information generation device or another delivery device. In the case where another delivery device performs delivery, the association information may be transmitted to the other delivery device.

It is preferable that the route information determination means refer to attribute information indicating an attribute of each of the components and a criterion for determination determined in advance for each piece of route information, and determine, for a component the attribute information on which meets the criterion for determination, route information corresponding to the criterion for determination to be route information for the component.

With the foregoing configuration, attribute information indicating an attribute of each component and a criterion for determination determined in advance for each piece of route information are referred to and, for a component the attribute information on which meets the criterion for determination, route information corresponding to the criterion for determination is determined to be route information for the component.

Therefore, with the foregoing configuration, route information in accordance with a predetermined criterion for determination is automatically determined. Note that a predetermined criterion for determination may be a criterion as to whether or not the file size of a component exceeds a predetermined upper limit in the case where route information is information that specifies a delivery route that can support delivery of large-volume content, such as broadcast delivery, for example. In this case, attribute information to be referred to is the file size of the component.

It is preferable that the association information generation means bring components together in a group, pieces of route information for the components determined by the route information determination means being identical, and associate route information with the group.

With the foregoing configuration, components are brought together in a group, determined pieces of route information for the components being identical, and route information is associated with the group. As a result, in the case where there are a plurality of components for which the same route information is determined, association information in which the route information is associated with a group constituted by the plurality of components is generated. By using such association information, the components can be easily delivered in a group.

Note that the delivery device described in the present description and the association information generation device described in the present description may be implemented by using a computer. In this case, a control program that makes a computer implement the foregoing delivery device or the foregoing association information generation device by making the computer operate as means of the foregoing delivery device or the foregoing association information generation device, and a computer readable recording medium that records the control program are also within the scope of the present invention.

### INDUSTRIAL APPLICABILITY

The present invention can be used for delivery of multi-component content.

### REFERENCE SIGNS LIST

1, 1′, 1″ primary delivery server (association information generation device)
12, 12′, 12″ route setting unit (route information determination means, association information generation means)
30 component
31 component management information (association information)
2 secondary delivery server (delivery device)
40 first reception unit (reception unit)
40′ second reception unit (reception unit)
40″ third reception unit (reception unit)
51 delivery control unit (delivery control means)
52 route determination unit (route determination means)
60 component
61 component management information (association information)
80 secondary delivery server (delivery device)
53 service design unit (secondary association information generation means)
62 service route information (secondary association information)
90 primary delivery server (association information generation device, delivery device)
15 service design unit (secondary association information generation means)
16 selection unit (delivery control means, route determination means)
32 service route information (secondary association information)
132 service provider server (delivery device)
142 relay server (delivery device)

1.-17. (canceled)

18. A delivery device that delivers content constituted by a plurality of components, comprising:
a storage unit that stores component management information containing pieces of route information used to specify delivery routes of the components, wherein
each of the pieces of route information contains information indicating any one of immediacy, high reliability, and bidirectionality of a delivery route of a corresponding component among the components.

19. The delivery device according to claim 18, wherein the information indicating bidirectionality is information indicating whether or not the component is for bidirectional delivery.

20. The delivery device according to claim 18, wherein the information indicating high reliability is information indicating resilience of the component to loss.

21. The delivery device according to claim 18, wherein the information indicating immediacy is information indicating an allowance for end-to-end delay time in delivery of the component.

22. The delivery device according to claim 18, further comprising:
a route determination unit that determines delivery routes of the components that constitute the content in accordance with the component management information; and
a transmission unit that transmits the components using the delivery routes determined by the route determination unit.

23. A delivery method of delivering content constituted by a plurality of components, the method comprising:
a storage step of storing component management information containing pieces of route information used to specify delivery routes of the components;
a route determination step of determining delivery routes of the components that constitute the content in accordance with the component management information; and
a transmission step of transmitting the components using the delivery routes determined in the route determination step, wherein
each of the pieces of route information contains information indicating any one of immediacy, high reliability, and bidirectionality of a delivery route of a corresponding component among the components.

24. A reception device that receives the components delivered from the delivery device according to claim 22.
